(19) United States
(12) Patent Application Publication
(10) Pub. No.: US 2006/0168045 A1
(43) Pub. Date: Jul. 27, 2006

(54) System and method for e-mail client with proactive indication unit

(76) Inventor: Clifford Alan Pickover, Yorktown Heights, NY (US)

Correspondence Address: Whitham, Curtis, & Christofferson, P.C., Suite 340, 11491 Sunset Hills Road, Reston, VA, 20190, US

(21) Appl. No.: 11/034,252

(22) Filed: Jan. 13, 2005

(51) Int. Cl. G06F 15/16

(52) U.S. Cl. 709/206

(57) ABSTRACT

A system and method provide an enhanced e-mail (electronic mail) system with a proactive indication of recipient away message. The system and method provide an enhanced e-mail system with a proactive indication of away messages of individuals related to the recipient. The system and method also provides for enhanced e-mail with a variety of away messages automatically sent based on criteria such as the nature of the e-mail sender, the date the e-mail was received, and the content of the e-mail.

### BACKGROUND OF THE INVENTION

1. Field of the Invention

This invention relates to e-mail systems on computer systems, and more specifically, the invention relates to a proactive indication of recipient away messages as provided by e-mail systems.

2. Background Description

Electronic mail, commonly referred to as e-mail, typically consists of text messages and attached files sent in a machine-readable data format from one computer user to another over a network. To send or receive e-mail, a computing device such as a computer or personal digital assistant (PDA) may be used connected to other devices over a wired or wireless network. E-mail addresses are often in a form such as name@company.com. Various e-mail client programs exist, such as those provided by Lotus Notes and Microsoft Outlook Express as well as Web-based e-mail systems such as Gmail, Hotmail and Yahoo.

E-mail clients are applications that run on a personal computers, PDAs, phones, or workstations and enable users to send and receive e-mail. The term “client” refers to the fact that user-level e-mail software is typically developed for use on the client side in a client-server computer network architecture. E-mail messages are often sent from many e-mail clients to a central e-mail server, which reroutes each message to its intended destination. The term “client” may also be used more generally to refer to any computing device or computing application that is connected, at some point in time, to a computer network.

E-mail has become ubiquitous and provides faster delivery of information than traditional paper mail. One advantage of e-mail over traditional paper mail, in addition to speed, is that e-mail systems typically provide each user with the capability of sending automated away messages in reply to e-mail messages received during a time period when the user does not expect to have normal access to incoming e-mail, such as when the user is out of the office on business or for personal reasons.

3. Problems with the Prior Art

While automated away messages are helpful, the fact that automatic away messages are sent only in response to e-mail messages means that automated away messages cannot be received until after a sender has spent a great deal of time composing an e-mail message that may be unnecessary or superfluous in light of the recipient's absence. Automated away messages do not prevent e-mail users from spending a great deal of time composing e-mail messages only to learn after the e-mail is sent that the recipient is away, for example away on vacation for nine days. This causes dissatisfaction for users of e-mail systems, who may prefer not to spend time and effort composing e-mail messages that will not reach the intended recipients on time.

### SUMMARY OF THE INVENTION

An exemplary object of the present invention is an improved system and method for providing an enhanced e-mail system with a proactive indication of recipient away message. Another exemplary object of this invention is an improved system and method for providing an enhanced e-mail system with a proactive indication of away messages of individuals related to the recipient. A further exemplary object of this invention is an improved system and method for providing an enhanced e-mail system with a variety of away messages automatically sent based on criteria such as the nature of the e-mail sender, the date the e-mail was received, and the content of the e-mail.

According to the present invention, a method for sending and receiving e-mail is provided, wherein an e-mail server sends one or more away messages for one or more e-mail users even if no e-mail message has been sent to said e-mail users, and an e-mail client interface displays an indication of the away status of one or more e-mail users to whom an e-mail message is being composed, before the message is sent to e-mail users who are away. In some embodiments, the e-mail server may send away messages upon request from an e-mail client, while in other embodiments the e-mail server may send e-mail messages, when they are created, to a database or other data storage means accessible by e-mail clients while messages are being composed.

There are a variety of ways in which an e-mail client interface may indicate the away status of an e-mail user. In addition to individual away messages, aggregate away messages may also be provided; for example, if twenty out of sixty members of a department are away for specified duration of time, an aggregate away message may be determined that says, for example, “30% of Steve's department is away during the week of December 25.” Computation of such an aggregate away message may be determined using standard methods, for example, computing a percentage of people away based on a knowledge of the total number of people in a relationship such as a group or department In addition, away messages may be provided in conventional text-based format or in an unconventional format such as audio and/or video formats.

In some embodiments, the indication of the away status of an e-mail user may include displaying the user's away message on a field of the e-mail client interface. In other embodiments, the indication of the away status of an e-mail user may include an audio or visual indicator on the e-mail client interface signaling that an away message is available for review. In further embodiments, an away message may displayed when the user of the e-mail client interface hovers with a mouse cursor over the name, e-mail address, or other user ID of the e-mail user to whom the away message relates.

An away message may be provided along with information identifying alternative contacts for the e-mail user to whom the away message relates. Identification of such alternative contacts may or may not include the name, e-mail address and/or other user ID for each alternative contact and and may or may not include an indication of the away status of each alternative contact. Such alternative contacts may either be identified by the user at the time the away message is created or automatically created on the basis of rules; for example, an e-mail user's manager and/or secretary could automatically be identified as alternative contacts.

An e-mail user creating an away message may specify a plurality of away messages that may be sent according to attributes associated with particular e-mail client interfaces. Examples of such attributes may include, without limitation: the name, user ID, e-mail address, language, reading level, and/or country of the e-mail user to whom the away message is to be sent; whether the away message is to be sent via an Intranet or the public Internet; the content of the e-mail message being composed by the e-mail user to whom the away message is to be sent, as indicated by automatic topic determination; the time, date, number and/or nature of attachments to the e-mail message being composed by the e-mail user to whom the away message is to be sent; other functions, including, but not limited to, a function of time, date, and/or the number of times (N) a recipient has received an e-mail message from the e-mail user to whom the away message is to be sent.

The invention, therefore, is an improved system and method for providing an enhanced e-mail system with a proactive, on-the-fly, indication of recipient away messages. The invention is an improved system and method for providing an enhanced e-mail system with a proactive indication of away messages of individuals related to the recipient. The system and method of the invention also provides for enhanced e-mail with a variety of away messages automatically sent based on criteria such as the nature of the e-mail sender, the date the e-mail was received, and the content of the e-mail.

### BRIEF DESCRIPTION OF THE DRAWINGS

The foregoing and other objects, aspects, and advantages will be better understood from the following non-limiting detailed description of preferred embodiments of the invention with reference to the drawings that include the following:

FIG. 1 is a block diagram of one preferred embodiment of the proactive indication of away message in an e-mail client.

FIG. 2 is a block diagram of one preferred embodiment of the proactive indication of away message in an e-mail client, with an emphasis on the client interface.

FIG. 3 is a flow chart showing a mechanism for proactively presenting the recipient away message and the related away messages.

FIG. 4 is a flow chart showing a mechanism for determining away message based on various criteria associated with the incoming e-mail.

FIG. 5 is a presentation of one preferred embodiment of an information file that may control the specific nature of the away message based on criteria.

### DETAILED DESCRIPTION OF A PREFERRED EMBODIMENT OF THE INVENTION

The present invention addresses the above-mentioned limitations of the prior art by introducing a system that allows a user of a computing device to receive an on-the-fly and proactive determination of recipient e-mail away message. E-mail is a ubiquitous communication channel for users of computing systems. Users not uncommonly send e-mail only to find out several minutes later that the intended recipient is away for a week. This problem is solved with a proactive placement of the recipient's away message in the compose window of the sender's e-mail client or in other locations of the user's computer screen. Additional indicators of away messages described herein will promote user satisfaction and reduce quantities of unnecessary e-mail.

In one scenario, a user enters the recipient address of e-mail in the standard e-mail client, such as in the Lotus Notes “To” field. Before the user composes his message, he sees the “away message” of the recipient in a small graphical element of his client. Thus, the potential sender of the e-mail may not even bother composing the e-mail if his recipient is gone for a week, and the sender needs a quick answer. One way to embody this is for the system to probe the away messages of recipients and returning them quickly to sender before the e-mail is composed. Alternatively, recipient away messages may be stored by a service bureau in a database which is quickly accessed by a sender so that a visual indication of the away message appears at top of sender's mail before e-mail message is composed. Even a several second's delay exists for the proactive indication to appear, a user will appreciate this feature because he may abandon typing an otherwise lengthy e-mail.

This proactive indication of away message is a particular advantage for users of small mobile devices with small or hard-to-use keyboards or other information input devices. In these cases, message composition can be quite tedious.

Adjacent to this indication of “away message” may be one or more colored indicator areas showing the “presence state” of the recipient's assistant or managers—for example whether or not they are logged on or have away messages themselves. These indicators may be displayed as colored regions adjacent to the recipient away message window. For example, a color may indicate the length of time for which someone is away.

Using this invention, wasted e-mail sending is reduced. Many people will not bother to send e-mail if they view the away message in the proactive indication window. This proactive presentation of away message is not the same idea as probing whether a potential recipient is simply logged on or away from his desk, because an away message carries much additional information.

Additionally, the recipient may not be restricted to having a single away message but rather can have a plurality of away messages that will be sent according to the nature of the sender of e-mail (e.g. dependent on country of sender, Intranet versus Internet, name of sender, etc.). These away messages may be stored in a database.

A prospective e-mail sender may also receive proactive away content of a recipient by “hovering” with a mouse-driven cursor over the name of the recipient in the e-mail client “To field”, which causes the away message to pop up, typically displaying the duration of the expected away time of the recipient and any other information the recipient wishes to provide. These characteristics will become apparent in the following descriptions and embodiments.

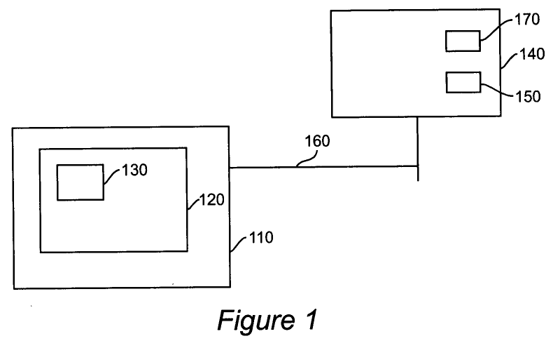

FIG. 1 shows a computing device with the proactive e-mail client. A computer 110 typically has a screen 120 in which a user views information. The user interface for the proactive e-mail client is typically displayed in a window 130 on screen 110. A remote computer 140 functioning as a server may contain a database 150 the stores the away messages for various users of the e-mail system. This database is available to the user and his computer 110 over network 160. A database 170 may be used to store relationships between individuals. For example, database 170 may contain company employee hierarchies, such as which individuals are managers and secretaries for other individuals.

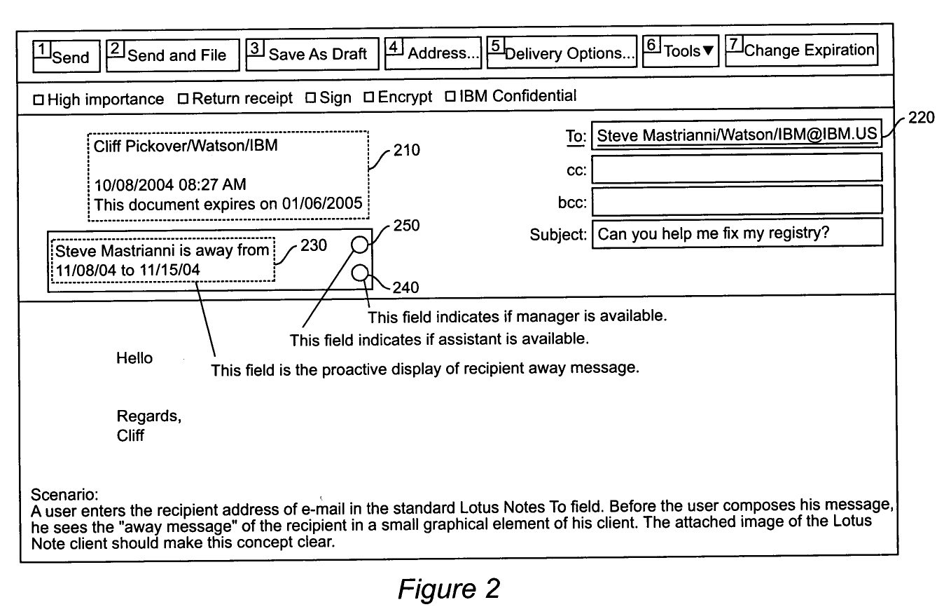

FIG. 2 shows the e-mail client 120 interface, which typically contains a “From” field 210 in which the e-mail sender's ID appears. Also shown is a “To” field 220 that typically shows the recipients e-mail address. This recipient address may be entered manually by a sender using a keyboard, or it may be automatically entered, for example, when a user selects “Reply” to an already existing e-mail. Similarly, the address in the “To” field may be entered when a user selects or types a nickname or “alias” for the user's true address. This alias is often converted automatically to the actual e-mail address.

Field 230 is a region of the e-mail client that contains a proactive indication of the recipients e-mail away message or other message. For example, text may appear in field 230 that says “Steve Jones will be on vacation from 11-11-05 to 11-20-05. Please contact his secretary at extension 3630 for emergencies.” Indicators 240 and 250 will provide information as to the away status of individuals related to the recipient, such as the manager of the recipient and the secretary of the recipient. These indicators may give a graphical indication of their status through the use of colors or other graphical attributes or may be sufficiently large to contain away message texts for these related individuals.

In addition to the proactive display of away messages in 230, 240, and 250, away messages may be displayed in other regions 260 of the computer screen, including the operating system's task bar.

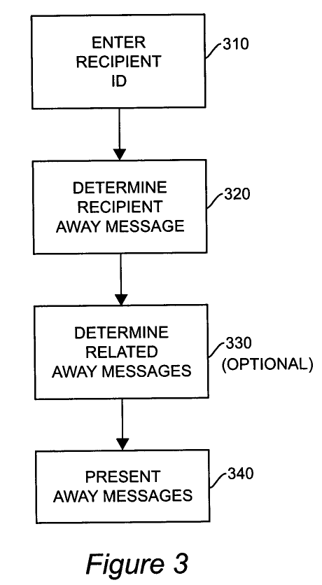

FIG. 3 shows a sequence of steps in a preferred embodiment of the proactive display of e-mail away messages. In step 310, the recipient's e-mail address is entered. In step 320, the recipient's away message is determined. This may be accomplished in various ways. For example, a recipient may set an away message in the form of text, such as “Steve Jones will be on vacation from 11-11-05 to 11-20-05. Please contact his secretary at extension 3630 for emergencies.” This text may be stored in a database 150 accessible to the user over a network 160. For example, the database may consist of various records, each record containing a user ID such as an e-mail address and an away message. The system scans the database using traditional techniques to identify the away message for a particular recipient.

In step 330, the system optionally determines the away status or away messages of people related to the recipient. For companies, relationships are often available to employees in the form of company and departmental organization charts and other web-accessible databases. This relationship database 170 may contain information such as which employees are managers of others or which secretaries work for which people. Once the relationship is determined, the away messages may be determined in a manner similar to that as described for step 320 by scanning database 150 accessible to the user over a network 160. The system scans the database using traditional techniques to identify the away message for particular related individuals. If desired, the system can determine in steps 320 and steps 330 the away messages of several individuals and determine an “aggregate” away message. For example, if twenty out of sixty members of a department are away for specified duration of time, an aggregate away message may be determined that says, for example, “30% of Steve's department is away during the week of December 25.” Computation of this aggregate away message can be determined using standard methods, for example, computing a percentage of people away based on a knowledge of the total number of people in a relationship, such as a group or department.

In step 340, the away information is presented to the user as described in FIG. 2. For example, the recipient's away message as well as the related individuals away messages or aggregate away messages may be displayed in various areas 230, 240, 250, 260 at essentially the moment a user types a recipient e-mail address in field 220. In some cases, it may be useful to condense the away information, such as textual information, for the related individuals and simply show their away status as a graphical indication, such as color. The away message may also be presented in audio format. For example, the away message may be converted, using text-to-speech software and hardware, to an audio message. Alternatively, the original e-mail away message may have been stored by the recipient in an audio format. These audio messages may be digitized and stored in database 150 for access and playback. Audio messages may be useful because users' screens are typically quite cluttered, and an audio message may get the user's immediate attention. As with the text messages, the audio messages are played to the user on-the-fly and proactively—as soon as possible after the user has entered the recipient's e-mail address. This decreases the amount of typing a user does when composing an e-mail before he understands that the recipient is away and understands other information conveyed in the recipient away message. In instances where the user may wish to proactively hear not only the away messages of the recipient but also the away messages of related individuals, rules can be used to establish the timing of such audio playback. For example, the away message of the recipient may be played first, followed by those of the manager or secretary. If no away message exists, then typically the user will not hear any audio.

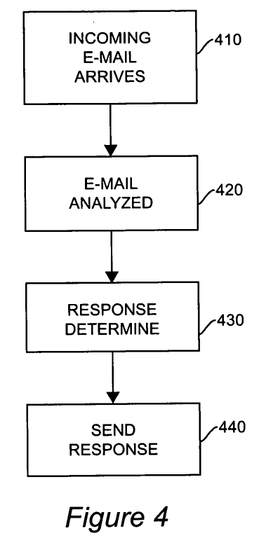

FIG. 4 shows how evolving away messages may be specified and sent to individuals who send e-mail. Recipients of e-mails may not be restricted to having a single away message but rather can have a plurality of away messages that will be used depending on the nature of the sender and/or time a message arrives. For example, the system may be able to determine various aspects of incoming e-mail and the sender of the e-mail. For instance, if the e-mail arrives on 12-24-05, is in German, comes from the Internet and not the recipient's company Intranet, and comes from “Suzy”, the away message that Suzy receives many be different than if the e-mail arrives on 12-26-05 (a day after Christmas), is in French, comes from the recipient's company Intranet, and comes from “Bill” with a large image attachment. As the date changes, the away message may change in a gradual manner.

In step 410, an e-mail arrives. In step 420, the e-mail is analyzed for such information as sender ID, topic, language, date, nature of attachments, and so forth. Topic determination may be performed by one of many methods known in the prior art, such as an analysis of words in an e-mail and latent semantic indexing. Reading level of the e-mail may also be assessed using known methods.

In step 430, an away response is determined based on the analysis performed in step 420. For example, if the incoming e-mail is in German, the response may be in German.

In step 440, the response is returned to the sender of the incoming e-mail using automated “away message” sending techniques typically provided by e-mail clients.

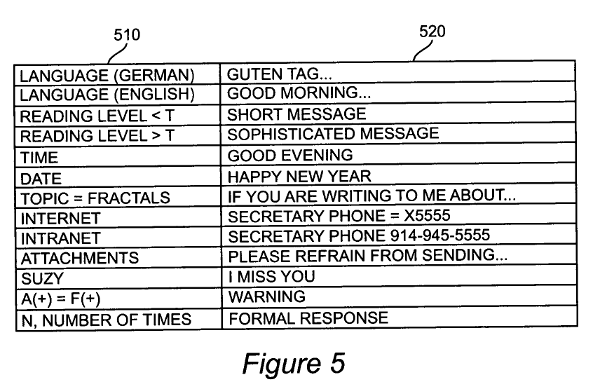

FIG. 5 is a datable that may be part of database 150. This database contains a variety of away messages set by or available to a user, and is used for determining a response 430. Once the analysis is completed in step 420, the system may use various criteria 510 to determine which of many possible away messages 520 may be sent. The use and assessment of language in an e-mail may be appropriate when a user has friends in different countries or when he works for a multinational corporation. Reading levels may be useful when teachers are away and may receive mail from young students. For example, if a reading level of an incoming message is below a threshold T, the mail may be from a student and the away message adjusted accordingly. The away message A(t) may be a gradual function f(t) of the time and date. So, for example, as the date gets closer to a particular deadline, the away message can become more insistent. Or as the date gets closer to Christmas, the message can become more cheerful. Thus, the criteria 510 may include functions of dates, and the messages 520 may change in response to these dates.

Another criterion 510 is the number of times, N, a recipient has received an e-mail from a sender who is typically identified by an e-mail address. For example, if N=0, which means that the recipient has never received a message from the sender, the away message in 520 may be more formal.

Using the approach outlined here, a company may provide e-mail client interfaces 130 that present a proactive indication of the away message of an addressed e-mail recipient. The proactive indication may include the away message of associates or individuals related to those of the addressed e-mail recipient, such as a secretary, manager, parent, teacher, or supervisor.

An e-mail recipient may specify a plurality of away messages that will be sent according to the nature of the sender of e-mail (e.g., dependent on country of sender, language, reading level, intranet versus Internet, name of sender, content of sender message as assessed from automatic topic determination, nature of attachments, time, date, etc.). These different away messages may increase the satisfaction of e-mail users by providing a pleasant, personalized away message that may also provide relevant information to a sender's needs. Away message is displayed in the e-mail client window or anywhere on the computer screen. The away message may also be presented in audio format, which may be useful for visually impaired users, or simply to get the attention of a user. The away message may also be displayed on the e-mail interface 120 when the user hovers with a mouse cursor over the name of the recipient, such as hovering above the field 220. The display of the away message may also hover near the mouse cursor.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

Having thus described my invention, what I claim as new and desire to secure by Letters Patent is as follows:

1. A method for sending and receiving electronic mail, comprising the steps of:
sending by an electronic mail server one or more away messages for one or more electronic mail users even if no electronic mail message has been sent to said electronic mail users; and
displaying by an electronic mail client interface an indication of the away status of one or more electronic mail users before an electronic mail message is sent to said electronic mail users.

2. The method of claim 1, further comprising the step of sending by said electronic mail server said away messages upon request from an electronic mail client.

3. The method of claim 1, further comprising the step of sending by said electronic mail server said away messages to a database or other data storage means accessible by said electronic mail client.

4. The method of claim 1, wherein said indication of the away status of an electronic mail user comprises the display of said away message on a field of an electronic mail client interface.

5. The method of claim 1, wherein said indication of the away status of an electronic mail user comprises the display of said away message in at least one portion of a computer display that is not included within a window of an electronic mail client interface.

6. The method of claim 1, wherein said indication of the away status of an electronic mail user comprises the display on an electronic mail client interface of an indicator that an away message is available for review.

7. The method of claim 1, wherein said away message is displayed when the user of an electronic mail client interface hovers with a mouse cursor over one or a plurality of a name, electronic mail address, and another user ID of the electronic mail user to whom the away message relates.

8. The method of claim 1, wherein said away message is provided to a user of an electronic mail client interface along with information identifying alternative contacts for the electronic mail user to whom the away message relates.

9. The method of claim 8, wherein said information identifying alternative contacts includes one or a plurality of an indication of an away status of and an away message for each such alternative contact.

10. The method of claim 1, wherein an electronic mail user creating an away message may specify a plurality of away messages that may be sent according to attributes associated with the electronic mail message being prepared for the away electronic mail user, or with the sender of the electronic mail message.

11. The method of claim 10, wherein said attributes include one or plurality of country of sender, language, reading level, Intranet versus Internet, name of sender, content of sender message as assessed from automatic topic determination, nature of attachments, time, date, number and nature of attachments, ID of the sender, a function such as a function of time or date, and the number of times (N) a recipient has received an e-mail from a sender.

12. The method of claim 1, wherein said away message is provided in audio format.

13. The method of claim 1, wherein said away message comprises an aggregate away message.

14. A system for sending and receiving electronic mail, comprising:
an electronic mail server which sends one or more away messages for one or more electronic mail users even if no electronic mail message has been sent to said electronic mail users; and
an electronic mail client interface which displays an indication of the away status of one or more electronic mail users before an electronic mail message is sent to said electronic mail users.

15. The system of claim 14, further comprising means for said electronic mail server to send said away messages upon request from an electronic mail client.

16. The system of claim 14, further comprising means for said electronic mail server to send said away messages to a database or other data storage means accessible by said electronic mail client.

17. The system of claim 14, further comprising means for said indication of the away status of an electronic mail user to display said away message on a field of an electronic mail client interface.

18. The system of claim 14, further comprising means for said indication of the away status of an electronic mail user to display said away message in at least one portion of a computer display that is not included within a window of an electronic mail client interface.

19. The system of claim 14, further comprising means for said indication of the away status of an electronic mail user to display on an electronic mail client interface of an indicator that an away message is available for review.

20. The system of claim 14, further comprising means for said away message to be displayed when the user of an electronic mail client interface hovers with a mouse cursor over one or a plurality of a name, electronic mail address and another user ID of the electronic mail user to whom the away message relates.

21. The system of claim 14, further comprising means for said away message to be provided to a user of an electronic mail client interface along with information identifying alternative contacts for the electronic mail user to whom the away message relates.

22. The system of claim 21, further comprising means for said information identifying alternative contacts to include an indication of one or a plurality of an away status of and an away message for each such alternative contact.

23. The system of claim 14, further comprising means for an electronic mail user to create an away message to specify a plurality of away messages that may be sent according to attributes associated with the electronic mail message being prepared for the away electronic mail user, or with the sender of the electronic mail message.

24. The system of claim 23, further comprising means for said attributes to include one or a plurality of country of sender, language, reading level, Intranet versus Internet, name of sender, content of sender message as assessed from automatic topic determination, nature of attachments, time, date, number and nature of attachments, ID of the sender, a function such as a function of time or date, and the number of times (N) a recipient has received an e-mail from a sender.

25. The system of claim 14, further comprising means for said away message to be provided in audio format.

26. The system of claim 14, further comprising means for said away message to comprise an aggregate away message.
